(19) United States
(12) Patent Application Publication
(10) Pub. No.: US 2010/0326819 A1
(43) Pub. Date: Dec. 30, 2010

(54) METHOD FOR MAKING A PATTERNED PERPENDICULAR MAGNETIC RECORDING DISK

(75) Inventors: Jeffrey S. Lille, Sunnyvale, CA (US); Neil Leslie Robertson, Palo Alto, CA (US)

Correspondence Address: THOMAS R. BERTHOLD, 18938 CONGRESS JUNCTION COURT, SARATOGA, CA, 95070, US

(73) Assignee: HITACHI GLOBAL STORAGE TECHNOLOGIES NETHERLANDS B.V., San Jose, CA (US)

(21) Appl. No.: 12/490,480

(22) Filed: Jun. 24, 2009

(51) Int. Cl. B44C 1/22

(52) U.S. Cl. 204/192.34; 216/22

(57) ABSTRACT

A method for making a patterned-media magnetic recording disk uses nano-imprint lithography (NIL) for patterning a resist layer over the magnetic recording layer. A hard mask layer is located above the magnetic recording layer and an etch stop layer is located above the hard mask layer and below the resist layer. Residual resist material in the recesses of the patterned resist layer is removed by reactive ion etching (RIE) to expose the underlying etch stop layer. The etch stop material in the recesses is then removed by RIE to expose regions of the hard mask layer. A reactive ion milling (RIM) process removes the exposed hard mask material. The RIM process causes no undercutting of the unexposed hard mask material, which allows the very small critical dimensions of the patterned-media disk to be reliably achieved when ion milling is subsequently performed through the hard mask that has been patterned by the RIM process.

### BACKGROUND OF THE INVENTION

1. Field of the Invention

This invention relates generally to patterned-media perpendicular magnetic recording disks, and more particularly to a method for making the disks.

2. Description of the Related Art

Magnetic recording hard disk drives with patterned magnetic recording media have been proposed to increase data density. In patterned media the magnetic recording layer on the disk is patterned into small isolated data islands arranged in concentric data tracks. Patterned-media disks may be perpendicular magnetic recording disks, wherein the magnetization directions of the magnetized regions are perpendicular to or out-of-the-plane of the recording layer. To produce the required magnetic isolation of the patterned data islands, the magnetic moment of the spaces between the islands must be destroyed or substantially reduced to render these spaces essentially nonmagnetic.

Nano-imprint lithography (NIL) has been proposed to form the desired pattern of islands on patterned-media disks. NIL is based on deforming a resist layer by a master template or mold having the desired nano-scale pattern. The mold is made by a high-resolution lithography tool, such as an electron-beam tool. The recording layer to be patterned is formed as a continuous layer on the disk substrate. Then the recording layer is spin-coated with a thermoplastic polymer (resist) film, such as poly-methylemthacrylate (PMMA). The polymer is then heated above its glass transition temperature. At that temperature, the thermoplastic resist becomes viscous and the nano-scale pattern is reproduced on the resist by imprinting from the mold at a relatively high pressure. Once the polymer is cooled, the mold is removed from the resist leaving an inverse nano-scale pattern of recesses and spaces on the resist. As an alternative to thermal curing of a thermoplastic polymer, an ultraviolet (UV)-curable polymer can be used as the resist. The recording layer is then etched, using the patterned resist as a mask, and the resist removed, leaving the patterned data islands in the recording layer.

To achieve areal recording densities of Terabytes/square inch (Tb/in²), the lateral dimension of the islands and the nonmagnetic spaces between the islands are critical dimensions that are required to be extremely small, e.g., between 5 and 20 nm, and to have very small tolerances. This requires very precise control of the specific etching processes. Also, the NIL method for patterning the resist layer leaves regions of residual resist material beneath the patterned recesses, which must be removed before etching of the recording layer can be performed. This complicates the overall fabrication process.

What is needed is a method for fabricating patterned-media disks that uses the NIL method for patterning the resist layer but that allows for forming patterns with very small critical dimensions.

### SUMMARY OF THE INVENTION

The invention relates to a method for making a patterned-media magnetic recording disk wherein the method uses nano-imprint lithography (NIL) for patterning a resist layer over the magnetic recording layer. A hard mask layer, such as diamond-like carbon (DLC), is located above the magnetic recording layer and an etch stop layer is located above the hard mask layer and below the resist layer. The NIL patterning method results in a resist layer having a pattern of spaces and recesses between the spaces that define the critical dimensions of the data islands and the spaces between the data islands. As a result of the NIL process, the resist layer will also have regions of residual resist material in the recesses. The residual resist material is removed by reactive ion etching (RIE) in an oxygen-containing plasma to expose the underlying etch stop layer. The etch stop material in the recesses is then removed by RIE in a fluorine-containing or chlorine-containing plasma to expose regions of the hard mask layer. A reactive ion milling (RIM) process removes the exposed hard mask material. The RIM process uses a highly directional ion source at a substantially lower voltage applied to the substrate and at a substantially lower pressure than the RIE processes. The absence of a high bias voltage on the substrate and the very low pressure cause no undercutting of the unexposed hard mask material. This allows the critical dimensions of the patterned-media disk to be reliably achieved when ion milling is subsequently performed through the hard mask that has been patterned by the RIM process. As an alternative to the RIM process for removing the exposed hard mask material, a reactive ion beam etching (RIBE) may also result in removal of the hard mask material in the recesses without undercutting. In RIBE, the bias voltage to the substrate is less than in RIM and the removal of the hard mask material is dominated by chemical reaction rather than milling. The RIE and RIM (or RIBE) and ion milling processes may be performed sequentially in systems or chambers connected to a common vacuum system so the complete method of the invention can be performed without breaking vacuum.

For a fuller understanding of the nature and advantages of the present invention, reference should be made to the following detailed description taken together with the accompanying figures.

### BRIEF DESCRIPTION OF THE DRAWING

FIG. 1 is a top view of a patterned-media magnetic recording disk drive with a patterned-media magnetic recording disk.

FIG. 2 is a top view of an enlarged portion of a patterned-media disk showing the detailed arrangement of the data islands.

FIGS. 3A-3F are sectional views of a portion of a disk structure illustrating the method according to this invention for patterning the recording layer.

FIG. 4 is a sectional view of a typical perpendicular magnetic recording disk and shows the location of the recording layer in the stack of layers.

### DETAILED DESCRIPTION OF THE INVENTION

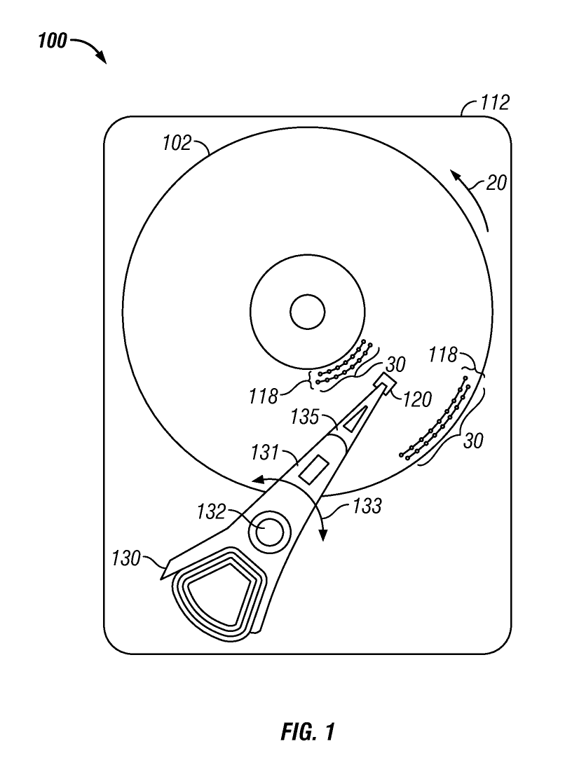

FIG. 1 is a top view of a patterned-media magnetic recording disk drive 100 with a patterned-media magnetic recording disk 102. The drive 100 has a housing or base 112 that supports an actuator 130 and a drive motor for rotating the magnetic recording disk 102. The actuator 130 may be a voice coil motor (VCM) rotary actuator that has a rigid arm 131 and rotates about pivot 132 as shown by arrow 133. A head-suspension assembly includes a suspension 135 that has one end attached to the end of actuator arm 131 and a head carrier, such as an air-bearing slider 120, attached to the other end of suspension 135. The suspension 135 permits the slider 120 to be maintained very close to the surface of disk 102 and enables it to “pitch” and “roll” on the air-bearing generated by the disk 102 as it rotates in the direction of arrow 20. A magnetoresistive read head (not shown) and an inductive write head (not shown) are typically formed as an integrated read/write head patterned as a series of thin films and structures on the trailing end of the slider 120, as is well known in the art. The slider 120 is typically formed of a composite material, such as a composite of alumina/titanium-carbide (Al₂O₃/TiC). Only one disk surface with associated slider and read/write head is shown in FIG. 1, but there are typically multiple disks stacked on a hub that is rotated by a spindle motor, with a separate slider and read/write head associated with each surface of each disk.

The patterned-media magnetic recording disk 102 includes a disk substrate and discrete data islands 30 of magnetizable material on the substrate. The data islands 30 are arranged in radially-spaced circular tracks 118, with only a few islands 30 and representative tracks 118 near the inner and outer diameters of disk 102 being shown in FIG. 1. The islands 30 are depicted as having a circular shape but the islands may have other shapes, for example generally rectangular, oval or elliptical. As the disk 102 rotates in the direction of arrow 20, the movement of actuator 130 allows the read/write head on the trailing end of slider 120 to access different data tracks 118 on disk 102.

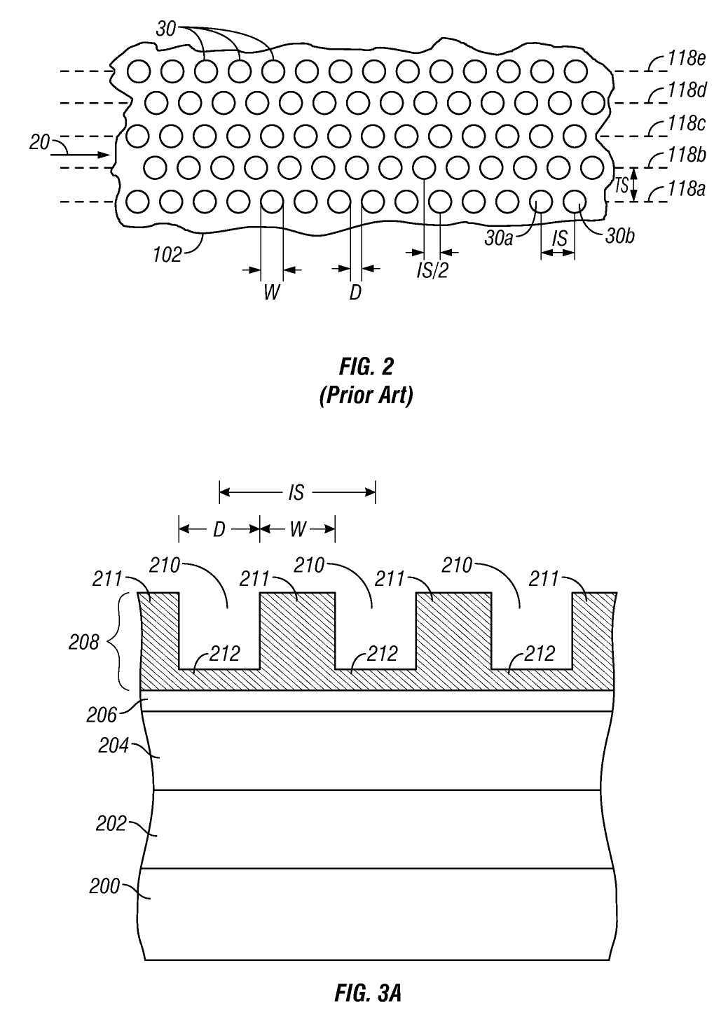

FIG. 2 is a top view of an enlarged portion of disk 102 showing the detailed arrangement of the data islands 30 on the surface of the disk substrate in one type of pattern according to the prior art. The islands 30 contain magnetizable recording material and are arranged in circular tracks spaced-apart in the radial or cross-track direction, as shown by tracks 118a-118e. The tracks are typically equally spaced apart by a fixed track spacing TS. The spacing between data islands in a track is shown by distance IS between data islands 30a and 30b in track 118a, with adjacent tracks being shifted from one another by a distance IS/2, as shown by tracks 118a and 118b. Each island has a lateral dimension W parallel to the plane of the disk 102, with W being the diameter if the islands have a circular shape. The islands may have other shapes, for example generally rectangular, oval or elliptical, in which case the dimension W may be considered to be the smallest dimension of the non-circular island, such as the smaller side of a rectangular island. The adjacent islands are separated by nonmagnetic spaces, with the spaces having a lateral dimension D. The value of D may be greater than the value of W.

Patterned-media disks like that shown in FIG. 2 may be longitudinal magnetic recording disks, wherein the magnetization directions in the magnetizable recording material in islands 30 are parallel to or in-the-plane of the recording layer in the islands, or perpendicular magnetic recording disks, wherein the magnetization directions are perpendicular to or out-of-the-plane of the recording layer in the islands. To produce the required magnetic isolation of the patterned data islands 30, the magnetic moment of the regions or spaces between the islands 30 must be destroyed or substantially reduced to render these spaces essentially nonmagnetic. The term “nonmagnetic” means that the spaces between the islands 30 are formed of a nonferromagnetic material, such as a dielectric, or a material that has no substantial remanent moment in the absence of an applied magnetic field, or a magnetic material in a trench recessed far enough below the islands 30 to not adversely affect reading or writing. The nonmagnetic spaces may also be the absence of magnetic material, such as trenches or recesses in the magnetic recording layer or disk substrate.

Patterned-media disks may be fabricated by any of several known techniques. In one technique a continuous magnetic recording layer is deposited onto the disk substrate and a polymeric resist layer is deposited over the recording layer. Nano-imprint lithography (NIL) is then used to form a pattern of recesses and spaces in the resist layer. The patterned resist layer is then used as a mask to etch the underlying recording layer to form the spaced-apart data islands.

One of the problems in this fabrication method arises as a result of the need to precisely control the extremely small and critical dimensions of the data islands and their spacing. For example, to achieve areal recording densities of Terabytes/square inch (Tb/in²), the lateral dimension W of the islands, i.e., the diameter for circular-shaped islands 30 (FIG. 2), may be between 2 and 30 nm and the lateral dimension D of the spaces between the islands may be between 2 and 30 nm, with likely values of W and D being between 5 and 20 nm. An additional problem, which also affects the ability to control the critical dimensions, is that NIL leaves regions of residual resist material beneath the patterned recesses, which must be removed before etching of the recording layer can be performed.

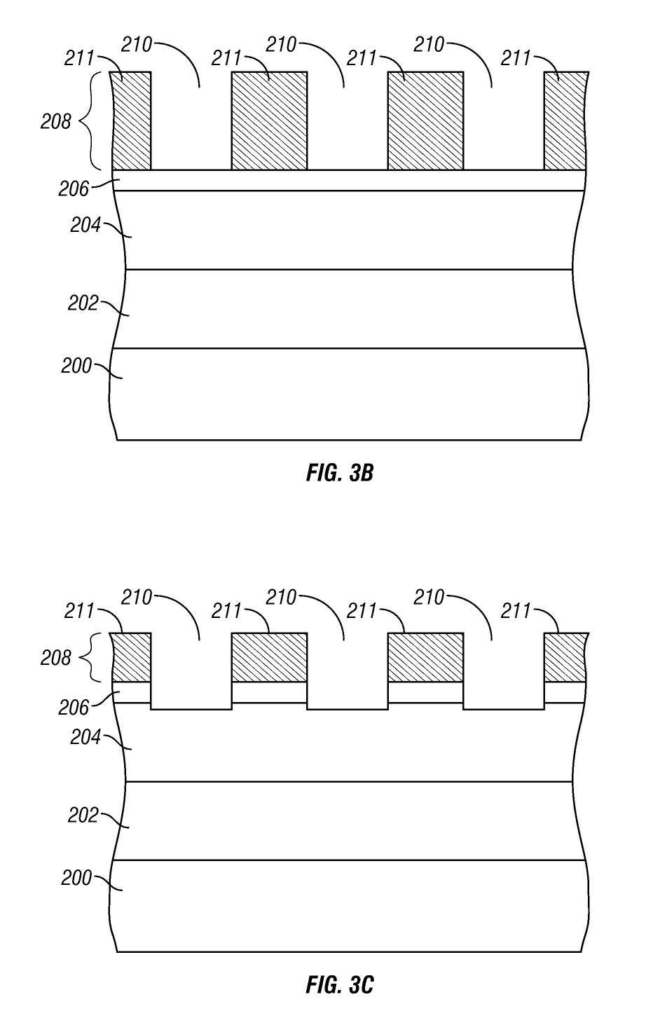

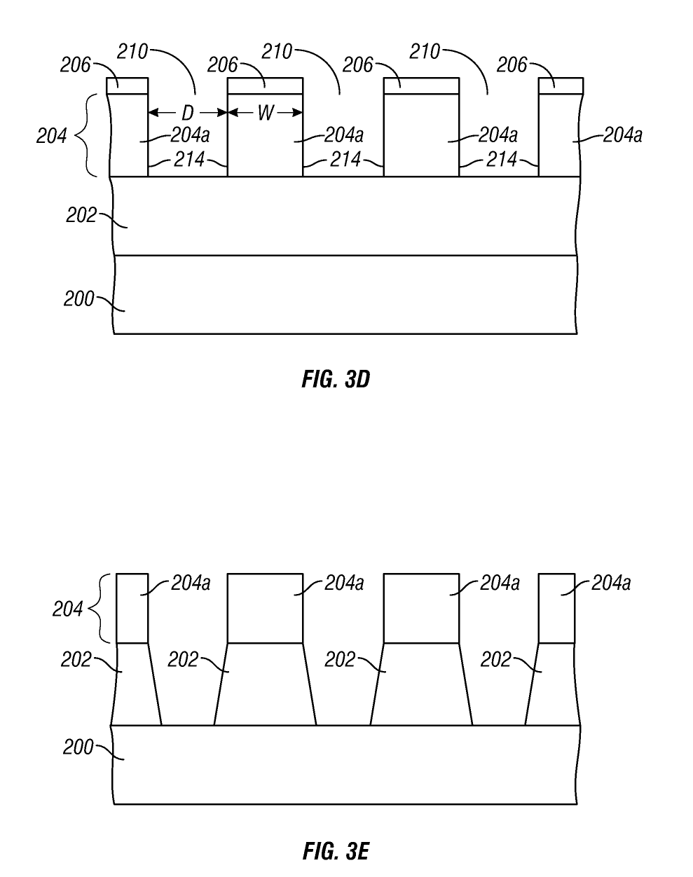

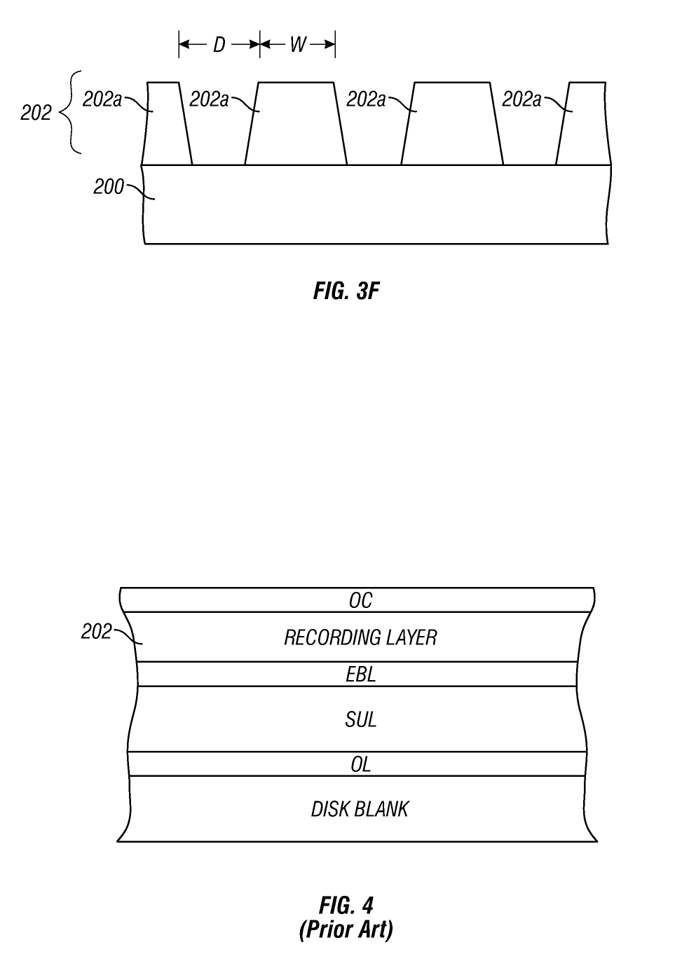

FIGS. 3A-3F are sectional views of a portion of a disk structure illustrating the method according to this invention for patterning the recording layer. Referring first to FIG. 3A, the recording layer 202 is a continuous layer formed over substrate 200. For ease of illustrating the method, only the recording layer 202 is depicted in FIGS. 3A-3F. However, the recording layer 202 is typically one layer in a stack of layers making up a perpendicular magnetic recording disk.

FIG. 4 is a sectional view of a typical perpendicular magnetic recording disk and shows the location of the recording layer 202. The hard disk blank may be any commercially available glass substrate, but may also be a conventional aluminum alloy with a NiP surface coating, or an alternative substrate, such as silicon, canasite or silicon-carbide. An adhesion layer or onset layer (OL) for the growth of a soft magnetic underlayer (SUL) may be an AlTi alloy or a similar material with a thickness of about 1-10 nm. The SUL acts as a flux return path for the magnetic write field and may be formed of magnetically permeable materials such as alloys of CoNiFe, FeCoB, CoCuFe, NiFe, FeAlSi, FeTaN, FeN, FeTaC, CoTaZr, CoFeTaZr, CoFeB, and CoZrNb, with a typical thickness of between about 50 to 400 nm. The SUL may also be a laminated or multilayered SUL formed of multiple soft magnetic films separated by nonmagnetic films, such as electrically conductive films of Al or CoCr. The SUL may also be a laminated or multilayered SUL formed of multiple soft magnetic films separated by interlayer films that mediate an antiferromagnetic coupling, such as Ru, Ir, or Cr or alloys thereof. An exchange break layer (EBL) is located on top of the SUL and acts to break the magnetic exchange coupling between the magnetically permeable films of the SUL and the recording layer 202 and may also facilitate epitaxial growth of the recording layer 202. The EBL may not be necessary, but if used it can be a nonmagnetic Ru or Ru alloy. The recording layer 202 may be formed of any of the known amorphous or crystalline materials and structures that exhibit perpendicular magnetic anisotropy. These include granular polycrystalline cobalt alloys, such as a CoPt or CoPtCr alloys, with a suitable segregant such as oxides of Si, Ta, Ti, Nb, Cr, V and B, and multilayers with perpendicular magnetic anisotropy, such as Co/Pt, Co/Pd, Fe/Pt and Fe/Pd multilayers, also containing a suitable segregant such as the materials mentioned above. A protective overcoat (OC) is typically formed on top of the recording layer 202 and may be an amorphous “diamond-like” carbon film or other known protective overcoats, such as Si-nitride.

Referring again to FIG. 3A, if the perpendicular magnetic recording disk is like that shown in FIG. 4, then the substrate 200 may be considered to be the hard disk blank with the SUL formed on it, with the recording layer 202 formed over the SUL. The recording layer 202 has a typical thickness of about 20 nm. A hard mask layer 204 is formed on the recording layer 202. The hard mask layer 204 may be diamond-like carbon (DLC) deposited by ion-beam deposition (IBD) to a thickness of about 20 nm. The hard mask layer 204 functions to precisely define the lateral dimensions of the islands that are formed when the recording layer 202 is subsequently etched through the hard mask layer 204. An etch stop layer 206 is formed on the hard mask layer 204 and the patterned resist layer 208 is formed on the etch stop layer 206. The etch stop layer 206 is formed of material that is resistant to the etching process used to remove the above resist layer 208 and resistant to the etching process used to pattern the underlying hard mask layer 204. The etch stop layer 206 may be formed of silica, a silicon nitride, or silicon carbide to a typical thickness between about 2 and 5 nm. The patterned resist layer 208 is formed by NIL and may be formed of any suitable polymeric material, such as poly-methylmethacrylate (PMMA) or a UV-curable polymer. The resist layer 208 has spaced-apart recesses 210 and spaces 211 that form a pattern that will be replicated in the underlying recording layer 202. The recesses 210 have a lateral dimension D parallel to the plane of the recording layer 202 and are spaced apart by an “island spacing” (IS) distance in the along-the-track direction. This results in spaces 211 of lateral dimension W between adjacent recesses 210. The value of D may be greater than the value of W, meaning that in the completed disk the space D between adjacent islands is greater than the width W of the islands. The dimensions D and W are critical dimensions necessary to fabricate a patterned disk with the desired areal density. Depending on the desired density, the dimensions D and W may each range between about 2 and 30 nm, more likely between about 5 and 20 nm. More importantly, in the completed patterned disk all of the data islands must have the same value of W and all the spaces between the islands must have the same value of D, within a small tolerance. Also shown in FIG. 3A is that as a result of the NIL process, the resist layer 208 will have regions 212 of residual resist material beneath the recesses 210 and above the etch stop layer 206.

In FIG. 3B the residual resist material in regions 212 (FIG. 3A) has been removed by reactive ion etching (RIE) in an oxygen (O₂) plasma. During RIE a large voltage difference is applied between two electrodes, one of which is the platter supporting the substrate 200, resulting in ions being directed toward the substrate and reacting with the residual resist material. The oxygen RIE is performed at a pressure greater than 1 mTorr, preferably between about 3 mTorr and 50 mTorr. The oxygen RIE is terminated at the etch stop layer 206 because the etch stop material is not affected by the oxygen RIE.

In FIG. 3C the etch stop material beneath the recesses 210 has been removed by reactive ion etching (RIE) in an fluorine-containing plasma, such as CHF₃ or CF₄, or a chlorine-containing plasma, such as BCl₃. This RIE removes some of the hard mask layer 204 and a portion of the resist layer 208, as shown by layer 208 in FIG. 3C being thinner than layer 208 in FIG. 3B.

In FIG. 3D portions of the hard mask layer 204 have been removed in the recesses 210 above the recording layer 202. The hard mask layer 204, which is DLC, is capable of being etched by oxygen RIE, like in the process for removal of the regions 212 of residual resist material (FIG. 3A). This process is desirable because it produces a relatively high etch rate, which is important for high-volume fabrication of patterned disks. However, in this invention it has been found that oxygen RIE, wherein the platter supporting the substrate 200 is one of the electrodes, and wherein the pressure is at about 5 mTorr or higher, results in undercutting of the hard mask material in areas 214. While this undercutting may be considered negligible in many applications, such as defining various features in semiconductor fabrication, it has been found to be unacceptable in fabricating patterned disks that require the critical dimensions W and D. For example, if W and D are desired to be 10 nm, an undercutting of only 1 nm in areas 214 would result in a variation of W and D by up to 20%, which is well beyond the dimensional tolerances necessary for reliable patterned disk fabrication.

Thus in the method of this invention portions of the hard mask layer 204 in the recesses 210 above the recording layer 202 are removed by reactive ion milling (RIM) in an oxygen plasma. Unlike RIE, RIM produces a highly directional ion source. In this technique there is a substantially lower voltage applied to the substrate and the pressure is maintained substantially lower, typically less than 1 mTorr and preferably only at 0.1 mTorr, than in oxygen RIE. The absence of a high bias voltage on the substrate 200 and the very low pressure cause no undercutting in regions 214, so that the critical dimensions W and D can be reliably achieved. Thus in FIG. 3D, after oxygen RIM the recesses 210 in hard mask layer 204 and the spaces 204a of hard mask material between the recesses 210 have lateral dimensions D and W, respectively, that precisely match the final dimensions D and W desired for the islands in the recording layer 202. While in the method of this invention oxygen RIM is the preferred technique for etching the hard mask layer 204, reactive ion beam etching (RIBE) may also result in removal of the hard mask material in the recesses without undercutting. In RIBE, the bias voltage to the substrate is less than in RIM and the removal of the hard mask material is dominated by chemical reaction rather than milling.

FIG. 3E shows the structure after ion milling with ions of an inert gas, such as Ar+ ions, to mill away portions of the recording layer 202 not protected by the hard mask layer 204. This ion milling also removes the remaining etch stop material that was above the hard mask layer 204. The ion milling is terminated after a predetermined time to assure that the substrate, i.e., the SUL if the perpendicular magnetic recording disk is like that shown in FIG. 4, is not also milled away. Alternatively, ion milling can be terminated by the well-known technique of secondary ion mass spectroscopy (SIMS).

FIG. 3F shows the resulting structure after removal of the remaining etch stop material by oxygen RIE. The recording layer 202 is now patterned into the individual islands 202a with lateral dimension W and spaces between the islands 202a with lateral dimension D.

All of the above described RIE, RIM and ion milling processes may be performed sequentially in systems or chambers connected to a common vacuum system so the complete method of the invention can be performed without breaking vacuum.

Following the method of this invention to form the individual islands 202a with the desired critical dimensions, a protective overcoat can be deposited on the tops of the islands 202a. This can be followed by a planarization process, typically by filling the spaces between the islands 202a with a polymeric planarizing material.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A method for making a patterned perpendicular magnetic recording disk comprising:
providing a rigid substrate;
depositing a perpendicular magnetic recording layer on the substrate, a hard mask layer on the recording layer, an etch stop layer on the hard mask layer, and a polymeric resist layer on the etch stop layer;
patterning the resist layer by imprint lithography to have a plurality of recesses with spaces between the recesses, the patterned resist layer having regions of residual polymeric material between the bottoms of said recesses and the etch stop layer;
removing said regions of residual polymeric material by reactive ion etching (RIE) in an oxygen-containing plasma to expose regions of etch stop material;
removing said regions of etch stop material by RIE in a plasma selected from a fluorine-containing plasma and a chlorine-containing plasma to expose regions of hard mask material;
removing said exposed regions of hard mask material by one of reactive ion milling (RIM) in oxygen and reactive ion beam etching (RIBE) in oxygen to expose regions of the underlying recording layer; and
ion milling the exposed regions of the recording layer.

2. The method of claim 1 wherein said recesses having a lateral dimension parallel to the plane of the recording layer greater than 2 nm and less than 30 nm and said spaces having a lateral dimension parallel to the plane of the recording layer greater than 2 nm and less than 30 nm.

3. The method of claim 2 wherein said recesses have a lateral dimension parallel to the plane of the recording layer greater than 5 nm and less than 20 nm and said spaces have a lateral dimension parallel to the plane of the recording layer greater than 5 nm and less than 20 nm.

4. The method of claim 1 wherein removing said regions of residual polymeric material by reactive ion etching (RIE) in an oxygen-containing plasma comprises removing said regions of residual polymeric material by RIE at a pressure greater than 1 mTorr and less than 50 mTorr, and wherein removing said regions of etch stop material by RIE in a plasma selected from a fluorine-containing plasma and a chlorine-containing plasma comprises removing said regions of etch stop material by RIE at a pressure greater than 1 mTorr and less than 50 mTorr.

5. The method of claim 4 wherein the RIE of the residual polymeric material and the RIE of the etch stop regions are performed at a pressure greater than 5 mTorr.

6. The method of claim 1 wherein removing said exposed regions of hard mask material by one of reactive ion milling (RIM) in oxygen and reactive ion beam etching (RIBE) in oxygen comprises removing said exposed regions of hard mask material at a pressure less than 1 mTorr.

7. The method of claim 1 further comprising, after ion milling the exposed regions of the recording layer, removing remaining hard mask material by RIE in an oxygen-containing plasma.

8. The method of claim 1 wherein the RIE of the residual polymeric material, the RIE of the etch stop regions, and the RIM of the hard mask regions and underlying recording layer regions are performed sequentially in a vacuum system without breaking vacuum.

9. The method of claim 1 wherein the hard mask layer comprises diamond-like carbon.

10. The method of claim 1 wherein the etch stop layer comprises a material selected from silica, silicon nitride and silicon carbide.

11. The method of claim 1 wherein said recesses have a lateral dimension D parallel to the plane of the recording layer and said spaces have a lateral dimension W parallel to the plane of the recording layer, and wherein D is greater than W.

12. A method for patterning a perpendicular magnetic recording layer into discrete islands in a structure comprising a rigid substrate, a continuous perpendicular magnetic recording layer on the substrate, a hard mask layer on the recording layer, an etch stop layer on the hard mask layer, and a polymeric resist layer on the etch stop layer and patterned into recesses and spaces between the recesses, wherein the patterned resist layer has regions of residual polymeric material between the bottoms of said recesses and the etch stop layer, and wherein said recesses have a lateral dimension D parallel to the plane of the recording layer greater than 2 nm and less than 30 nm and said spaces have a lateral dimension W parallel to the plane of the recording layer greater than 2 nm and less than 30 nm, the method comprising:
removing said regions of residual polymeric material by reactive ion etching (RIE) in an oxygen plasma at a pressure greater than 1 mTorr and less than 50 mTorr to expose regions of etch stop material;
removing said regions of etch stop material by RIE in a plasma selected from a fluorine-containing plasma and a chlorine-containing plasma at a pressure greater than 1 mTorr and less than 50 mTorr to expose regions of hard mask material;
removing said exposed regions of hard mask material by one of reactive ion milling (RIM) in oxygen and reactive ion beam etching (RIBE) in oxygen at a pressure less than 1 mTorr to expose regions of the underlying recording layer; and
ion milling the exposed regions of the recording layer, thereby patterning the recording layer into discrete magnetic islands having a lateral dimension W and nonmagnetic spaces having a lateral dimension D.

13. The method of claim 12 further comprising, after ion milling the exposed regions of the recording layer, removing remaining hard mask material by RIE in an oxygen plasma.

14. The method of claim 12 wherein the RIE of the residual polymeric material and the RIE of the etch stop regions are performed at a pressure greater than 5 mTorr.

15. The method of claim 12 wherein the RIE of the residual polymeric material, the RIE of the etch stop regions, and the RIM of the hard mask regions and underlying recording layer regions are performed sequentially in a vacuum system without breaking vacuum.

16. The method of claim 12 wherein the hard mask layer comprises diamond-like carbon.

17. The method of claim 12 wherein the etch stop layer comprises a material selected from silica, silicon nitride and silicon carbide.

18. The method of claim 12 wherein W is greater than 5 nm and less than 20 nm and D is greater than 5 nm and less than 20 nm.

19. The method of claim 12 wherein D is greater than W.
